(19) United States
(12) Patent Application Publication
(10) Pub. No.: US 2010/0164941 A1
(43) Pub. Date: Jul. 1, 2010

(54) SPREAD SPECTRUM CLOCKING INTERFACE APPARATUS OF FLAT PANEL DISPLAY

(76) Inventor: Jong-Seok Chae, Suwon-si (KR)

Correspondence Address: SHERR & VAUGHN, PLLC, 620 HERNDON PARKWAY, SUITE 320, HERNDON, VA, 20170, US

(21) Appl. No.: 12/636,026

(22) Filed: Dec. 11, 2009

(30) Foreign Application Priority Data
Dec. 29, 2008 (KR) 10-2008-0135763

(51) Int. Cl. G09G 3/36; G09G 5/00; H04B 1/707

(52) U.S. Cl. 345/214; 375/141; 375/E01.002; 345/99

(57) ABSTRACT

A spread spectrum clocking interface apparatus of a flat panel display for compensating for a frequency difference between a first clock signal externally supplied to a timing controller and a second clock signal generated from a spread spectrum clocking unit. The spread spectrum clocking interface apparatus includes a storage unit, first and second counters, and a delay unit. The storage unit stores input data to be supplied to the flat panel display in a first-in/first-out (FIFO) manner in accordance with a write address and outputs the stored input data in the FIFO manner in accordance with a read-out address. The first counter counts the first clock signal in response to a display enable signal and outputs a result of the counting as the write address. The delay unit delays the display enable signal while the second counter counts the second clock signal in response to the delayed display enable signal and outputs a result of the counting of the second counter as the read-out address.

The present application claims priority under 35 U.S.C. §119 to Korean Patent Application No. 10-2008-0135763 (filed on Dec. 29, 2008), which is hereby incorporated by reference in its entirety.

### BACKGROUND

Generally, a flat panel display (FPD) is a display device in which a sealed panel having an internal space is manufactured by bonding two substrates such as a front substrate and a back substrate. The FPD is provided with a structure capable of emitting light of a desired color at each pixel within the panel, to thereby render an image. For such a flat panel display, a liquid crystal display (LCD), a plasma display panel, a fluorescent display tube, an electron emission display, an organic light emitting diode display, etc. are well known.

Hereinafter, the configuration and operation of a related flat panel display will be described with reference to the accompanying drawings.

FIG. 1 is a block diagram schematically illustrating a related flat panel display. As illustrated in FIG. 1, the flat panel display includes display unit 10, timing controller 20, and signal processor 30. Signal processor 30 functions to supply data received from outside of the display in a wired or wireless manner and a command associated with the data to timing controller 20. Signal processor 30 receives a small signal in accordance with, for example, low voltage differential signaling (LVDS) from timing controller 20. In particular, a small signal differential transmission scheme such as reduced swing differential signaling or mini-LVDS is used generally in order to reduce electromagnetic interference (EMI).

Timing controller 20 performs a function to control display unit 10. For example, timing controller 20 outputs screen data to display unit 10, i.e., an LCD panel Timing controller 20 may alternatively control the timing of display unit 10. The recent tendency of displays to provide a higher-resolution screen causes an increase in the amount of input data and an increase in the frequency of a clock signal. In this regard, the amount of input data DATAIN supplied from signal processor 30 to timing controller 20 is large. Also, the frequency of a clock signal CLK1 supplied from signal processor 20 to timing controller 20 is high. However, when data is transmitted at high transmission rate, EMI or radio frequency interference (RFI) may be remarkably generated in lines used to transmit data to timing controller 20 and display unit 10.

FIG. 2 is a block diagram schematically illustrating timing controller 20 illustrated in FIG. As illustrated in FIG. 2, timing controller 20 includes receiver 22, spread spectrum clocking (SSC) unit 24, data processor 26, and SSC interface unit 28. Timing controller 20 uses SSC unit 24 in order to reduce or eliminate EMI. Receiver 22 receives a display enable (DE) signal, input data DATAIN, and first clock signal CLK1 from signal processor 30, and outputs the received signals and data to SSC interface unit 28. Data processor 26 includes blocks constituting a general configuration of timing controller 20, except for receiver 22 and SSC unit 24. Data processor 26 processes or generates a timing signal and data to be transmitted to display unit 10, and outputs the processed or generated timing signal and data to display unit 10 through output terminal OUT.

SSC unit 24 modulates first clock signal CLK1 and outputs the resultant signal as second clock signal CLK2. Meaning, SSC unit 24 performs a function to receive first clock signal CLK1, thereby generating second clock signal CLK2 in order to eliminate EMI from the flat panel display illustrated in FIG. 1.

A detailed configuration of SSC unit 24 is illustrated in, for example, FIG. 1 of Korean Unexamined Patent Publication No. 2002-0084488 (issued on Nov. 9, 2002). As illustrated in FIG. 1 of the publication, first clock signal CLK1 is supplied to first divider 110 as a reference input. Therefore, no detailed description will be given of SSC unit 24. SSC interface unit 28 receives first clock signal CLK1 from first clock signal CLK1, and second clock signal CLK2 from SSC unit 24, thereby performing an intrinsic function to synchronize data processor 26 and SSC unit 24. SSC interface unit 28 also outputs input data DATAIN, which contains the DE signal, to data processor 26. For this function, SSC interface unit 28 generally uses an SRAM as a buffer. However, where the SRAM is used as a buffer, the configuration of SSC interface unit 28 may be complicated.

### SUMMARY

Embodiments relate to a display device, and more particularly, to a spread spectrum clocking interface apparatus of a flat panel display.

Embodiments relate to a spread spectrum clocking interface apparatus of a flat panel display, which compensates for a frequency difference between a first clock signal supplied to a timing controller from outside of the apparatus and a second clock signal generated from a spread spectrum clocking (SSC) unit, using a simple configuration that does not use an SRAM.

In accordance with embodiments, a spread spectrum clocking interface apparatus of a flat panel display for compensating for a frequency difference between a first clock signal externally supplied to a timing controller and a second clock signal generated from a spread spectrum clocking unit can include at least one of the following: a storage unit which stores input data to be supplied to the flat panel display in a first-in/first-out (FIFO) manner in accordance with a write address, and outputs the stored input data in the FIFO manner in accordance with a read-out address; a first counter which counts the first clock signal in response to a display enable signal and outputs a result of the counting as the write address; a delay unit which delays the display enable signal; and a second counter which counts the second clock signal in response to the delayed display enable signal and outputs a result of the counting of the second counter as the read-out address.

In accordance with embodiments, a spread spectrum clocking interface apparatus of a flat panel display for compensating for a frequency difference between a first clock signal externally supplied to a timing controller and a second clock signal generated from a spread spectrum clocking unit can include at least one of the following: a storage unit which stores input data to be supplied to the flat panel display in a first-in/first-out (FIFO) manner in accordance with a write address; a first counter which counts the first clock signal in response to a display enable signal; a delay unit which delays the display enable signal; and a second counter which counts the second clock signal in response to the delayed display enable signal.

### DRAWINGS

FIGS. 1 and 2 illustrate a related flat panel display and a timing controller thereof.

Example FIGS. 3 and 4 illustrate a spread spectrum clocking (SSC) interface apparatus of a flat panel display and a waveform diagram of signals input/output to/from units, in accordance with embodiments.

### DESCRIPTION

Example FIG. 3 is a block diagram illustrating a spread spectrum clocking (SSC) interface apparatus of a flat panel display a waveform diagram of signals input/output to/from units. Example FIG. 4 is a waveform diagram of signals input/output to/from units illustrated in example FIG. 3.

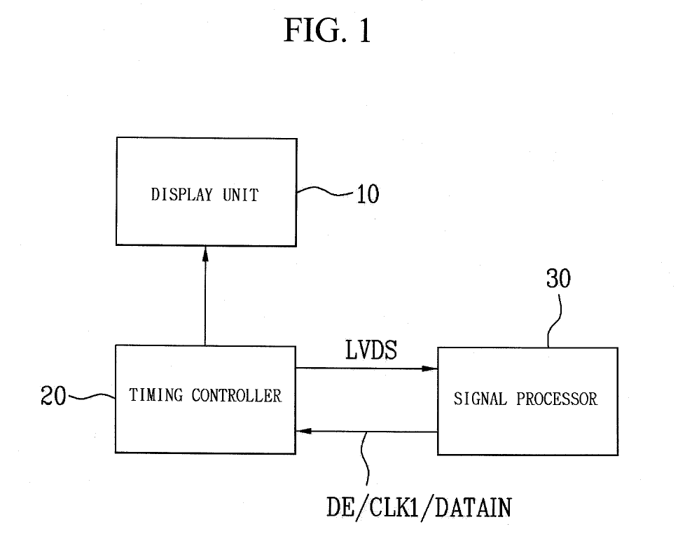

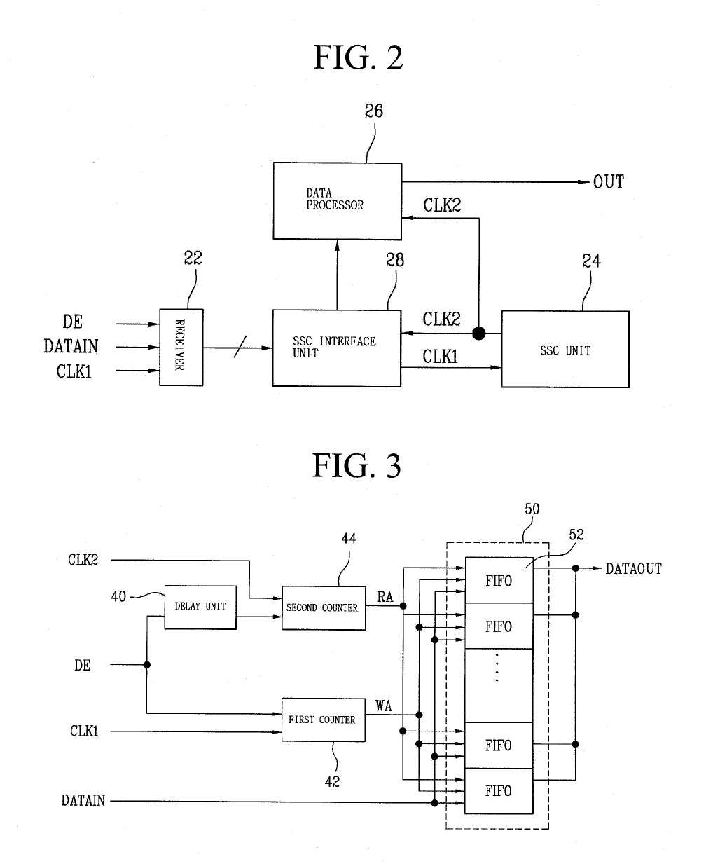

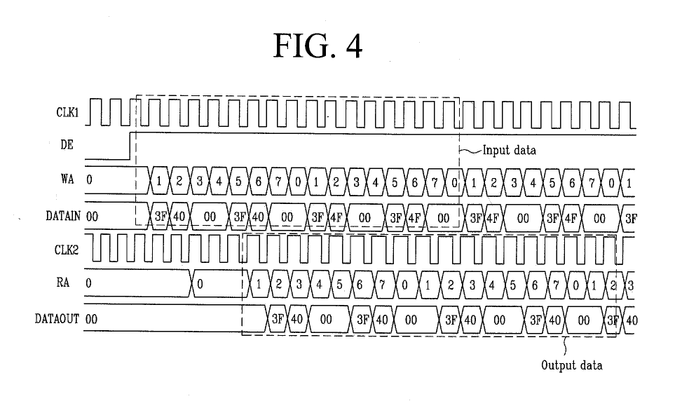

In accordance with embodiments, the SSC interface apparatus of example FIG. 3 performs the same function as the SSC interface apparatus illustrated in FIG. 2. Therefore, the peripheral configuration of the SSC interface apparatus in accordance with embodiments is identical to the circuits illustrated in FIGS. 1 and 2.

As illustrated in example FIG. 3, the SSC interface apparatus of the flat panel display includes storage unit 50, first counter 42 and second counter 44, and delay unit 40. The SSC interface apparatus in accordance with embodiments compensates for a frequency difference between first clock signal CLK1 and second clock signal CLK2 generated from SSC unit 24 in the following manner. As mentioned above in conjunction with FIGS. 1 and 2, first clock signal CLK1 is supplied from signal processor 30 to timing controller 20. Second clock signal CLK2 is supplied from SSC unit 24 to SSC interface unit 28.

Storage unit 50 stores input data DATAIN in a first-in/first-out (FIFO) manner in accordance with write address WA, and outputs stored input data DATAIN as output data DATAOUT, in the FIFO manner in accordance with read-out address RA. In this case, input data DATAIN is supplied from signal processor 10 to the SSC interface apparatus via receiver 22. Storage unit 50 may be implemented using n FIFO units 52. Each of the n FIFO units 52 is connected to input data DATAIN. Input data DATAIN is stored in FIFO unit 52 from among the n FIFO units 52, designated by write address WA. Input data DATAIN stored in FIFO unit 52, from among the n FIFO units 52, designated by read-out address RA is output as output data DATAOUT. In accordance with embodiments, a maximal value of “n” may be expressed by the following Expression 1:

$${n}_{max} = ( T 1 - T 2 ) \times \frac{2 D}{T 1}$$

where “nₘₐₓ” represents a maximal value of “n,” “D” represents the number of data contained in input data DATAIN, “T1” represents a period of first clock signal CLK1, and “T2” represents a period of second clock signal CLK2. Referring to Expression 1, it can be seen that each FIFO unit 52 functions as a buffer.

Hereinafter, the procedure of generating the write address WA and read-out address RA will be described. First counter 42 counts first clock signal CLK1 in response to display enable signal DE, and outputs the result of the counting as write address WA to storage unit 50. In this case, display enable signal DE is supplied to the SSC interface apparatus via receiver 22. Input data DATAIN supplied from signal processor 30 to timing controller 20 is stored in FIFO unit 52 designated by write address WA generated from first counter 42. In accordance with the characteristics of FIFO 52, input data DATAIN is sequentially stored in an input order thereof.

First counter 42 stops the counting operation thereof in a period in which there is no display enable signal DE. For example, as illustrated in example FIG. 4, first counter 44 executes the counting operation thereof in a period in which display enable signal DE has a “high” logical level, and stops the counting operation in a period in which there is no display enable signal DE, namely, a period in which display enable signal DE has a “low” logical level. Where display unit 10 of the flat panel display including the SSC interface apparatus in accordance with embodiments is a liquid crystal display panel, input data DATAIN stored in storage unit 50 in accordance with write address WA generated in the period, in which display enable signal DE has a “high” logical level, corresponds to data for one horizontal line in the liquid crystal display panel. When the logical level of display enable signal DE transits from the “low” logical level to the “high” logical level, the counting operation of first counter 44 is reinitiated. In this state, accordingly, data for a next horizontal line may be stored in storage unit 50 in accordance with the same operation as described above.

Delay unit 40 delays display enable signal DE received from signal processor 30. In this case, the delay time is determined in accordance with the number of input data DATAIN and first clock signal CLK1. The maximal delay time of display enable signal DE delayed by delay unit 40 may be expressed by the following Expression 2:

$${τ}_{max} = ( T 1 - T 2 ) \times \frac{D}{T 1}$$

where “τₘₐₓ” represents a maximal delay time of display enable signal DE delayed by delay unit 40.

Second counter 44 counts second clock signal CLK2 in response to the display enable signal delayed by delay unit 40 and outputs a result of the counting as read-out address RA to storage unit 50. The data stored in storage unit 50 is output as output data DATAOUT to data processor 26 in response to read-out address RA. Data processor 26 illustrated in FIG. 2 outputs output data DATAOUT illustrated in FIG. 3 as screen data to display unit 10 in sync with SSC unit 24. Thus, the screen data is displayed in the form of an image on display unit 10. Thus, the above-described delay unit 40 and second counter 44 perform a function of generating read-out address RA to determine the access time of input data DATAIN stored in storage unit 50.

The area of storage unit 50, from which input data DATAIN is read out in accordance with read-out address RA, is used as an area for again storing new input data DATAIN after a predetermined time period elapses. Storage unit 50 then outputs the new data from the area in which the new data is stored as output data DATAOUT in accordance with corresponding read-out address RA. First and second clock signals CLK1 and CLK2 are asynchronous. For this reason, write address WA which is generated in response to first clock signal CLK1 and read-out address RA which is generated in response to second clock signal CLK2, may be simultaneously generated. In order to avoid such a phenomenon, display enable signal DE is delayed by delay unit 40 and second counter 42 operates in response to the delayed display enable signal to generate read-out address RA. Accordingly, output data DATAOUT can be synchronized with SSC unit 24. Thus, EMI can be prevented.

As illustrated in example FIG. 4, it is possible to understand the procedure of generating write address WA in accordance with display enable signal DE and first clock signal CLK1. It is also possible to understand the procedure of generating read-out address RA in accordance with second clock signal CLK2. It is further possible to understand the procedure of storing input data DATAIN for one horizontal line in storage unit 50 and reading out the stored data as output data DATAOUT from storage unit 50 in accordance with read-out address RA.

As apparent from the above description, the SSC interface apparatus of the flat panel display in accordance with embodiments can be simply implemented because it uses FIFO units in place of SRAMs.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A spread spectrum clocking interface apparatus of a flat panel display which compensates for a frequency difference between a first clock signal externally supplied to a timing controller and a second clock signal generated from a spread spectrum clocking unit, the spread spectrum clocking interface apparatus comprising:
a storage unit which stores input data to be supplied to the flat panel display in a first-in/first-out (FIFO) manner in accordance with a write address, and outputs the stored input data in the FIFO manner in accordance with a read-out address;
a first counter which counts the first clock signal in response to a display enable signal, and outputs a result of the counting as the write address;
a delay unit which delays the display enable signal; and
a second counter which counts the second clock signal in response to the delayed display enable signal, and outputs a result of the counting of the second counter as the read-out address.

2. The spread spectrum clocking interface apparatus of claim 1, wherein the delay unit delays the display enable signal for a predetermined time determined in accordance with a number of the input data and the first clock signal.

3. The spread spectrum clocking interface apparatus of claim 2, wherein a maximum delay time of the display enable signal delayed by the delay unit is expressed as:
$${τ}_{max} = ( T 1 - T 2 ) \times \frac{D}{T 1}$$
where τₘₐₓ represents the maximal delay time, D represents the number of the input data, T1 represents a period of the first clock signal, and T2 represents a period of the second clock signal.

4. The spread spectrum clocking interface apparatus of claim 1, wherein the storage unit comprises n FIFO units each connected to the input data to store the input data when the FIFO unit is designated by the write address, and to read out the input data when the FIFO unit is designated by the read-out address.

5. The spread spectrum clocking interface apparatus of claim 4, wherein a maximum value of n is expressed as:
$${n}_{max} = ( T 1 - T 2 ) \times \frac{2 D}{T 1}$$
where nₘₐₓ represents the maximal value of n, D represents a number of data contained in the input data, T1 represents a period of the first clock signal, and T2 represents a period of the second clock signal.

6. The spread spectrum clocking interface apparatus of claim 1, wherein the flat panel display comprises a liquid display panel.

7. The spread spectrum clocking interface apparatus of claim 6, wherein the input data stored in the storage unit in accordance with the write address generated in response to the display enable signal corresponds to data for one horizontal line to be displayed on the liquid crystal display panel.

8. A spread spectrum clocking interface apparatus of a flat panel display which compensates for a frequency difference between a first clock signal externally supplied to a timing controller and a second clock signal generated from a spread spectrum clocking unit, the spread spectrum clocking interface apparatus comprising:
a storage unit which stores input data to be supplied to the flat panel display in a first-in/first-out (FIFO) manner in accordance with a write address;
a first counter which counts the first clock signal in response to a display enable signal;
a delay unit which delays the display enable signal; and
a second counter which counts the second clock signal in response to the delayed display enable signal.

9. The spread spectrum clocking interface apparatus of claim 8, wherein the storage unit outputs the stored input data in the FIFO manner in accordance with a read-out address.

10. The spread spectrum clocking interface apparatus of claim 9, wherein the second counter outputs a result of the counting of the second counter as the read-out address.

11. The spread spectrum clocking interface apparatus of claim 9, wherein the first counter outputs a result of the counting as the write address.

12. The spread spectrum clocking interface apparatus of claim 8, wherein the delay unit delays the display enable signal for a predetermined time.

13. The spread spectrum clocking interface apparatus of claim 12, wherein the predetermined time is determined in accordance with a number of the input data and the first clock signal.

14. The spread spectrum clocking interface apparatus of claim 13, wherein a maximum delay time of the display enable signal delayed by the delay unit is expressed as:
$${τ}_{max} = ( T 1 - T 2 ) \times \frac{D}{T 1}$$
where τₘₐₓ represents the maximal delay time, D represents the number of the input data, T1 represents a period of the first clock signal, and T2 represents a period of the second clock signal.

15. The spread spectrum clocking interface apparatus of claim 10, wherein the storage unit comprises n FIFO units each connected to the input data.

16. The spread spectrum clocking interface apparatus of claim 15, wherein the n FIFO units store the input data when the FIFO unit is designated by the write address.

17. The spread spectrum clocking interface apparatus of claim 16, wherein the n FIFO units reads out the input data when the FIFO unit is designated by the read-out address.

18. The spread spectrum clocking interface apparatus of claim 17, wherein a maximum value of n is expressed as:
$${n}_{max} = ( T 1 - T 2 ) \times \frac{2 D}{T 1}$$
where nₘₐₓ represents the maximal value of n, D represents a number of data contained in the input data, T1 represents a period of the first clock signal, and T2 represents a period of the second clock signal.

19. The spread spectrum clocking interface apparatus of claim 8, wherein the flat panel display comprises a liquid display panel.

20. The spread spectrum clocking interface apparatus of claim 19, wherein the input data stored in the storage unit in accordance with the write address generated in response to the display enable signal corresponds to data for one horizontal line to be displayed on the liquid crystal display panel.
